(19) United States
(12) Patent Application Publication
(10) Pub. No.: US 2010/0191746 A1
(43) Pub. Date: Jul. 29, 2010

(54) Competitor Analysis to Facilitate Keyword Bidding

(75) Inventors: Gang Wang, Beijing (CN); Jian Hu, Beijing (CN); Hua Li, Redmond, WA (US); Zheng Chen, Beijing (CN)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/360,096

(22) Filed: Jan. 26, 2009

(51) Int. Cl. G06F 17/30

(52) U.S. Cl. 707/750; 707/E17.014; 707/E17.017

(57) ABSTRACT

Disclosed herein are one or more embodiments that facilitate selection of keywords for bidding by an advertiser having a website. One or more of the disclosed embodiments may process a click-through log to determine measures of competitiveness for a plurality of websites extracted from the click-through log. Also, the one or more disclosed embodiments may, for one of the websites, determine a ranking of competing websites based at least in part on the measures of competitiveness. The ranking of competing websites may be used to facilitate selection of keywords for bidding.

### BACKGROUND

With the wide adoption of search engines, such as MS Live Search, search engine advertising has become an increasingly important tool for businesses to reach consumers. Search engine advertising often involves placing a banner advertisement or sponsored link in a prominent place among a number of search results. The sponsored advertisement or link is typically chosen based on bidding for keywords associated with user queries submitted to websites. An advertiser winning the bid for a given keyword will have its advertisement or link displayed when a user enters that keyword in a search query.

To select an optimal set of keywords for bidding, advertisers often utilize keyword tools. These tools typically provide a number of keyword statistics such as search volume, cost per click, search volume trends, estimated advertisement position, etc., based on advertisement click-though data and enable an advertiser to see sources where traffic has been generated from.

FIG. 1 illustrates the use of traditional keyword tools to suggest keywords for bidding. As shown, an advertiser 102 has its advertisement or link displayed to a user in response to a query 104, and the user clicks through to an advertiser website 106. A keyword tool 108 then uses data associated with user search behavior, including clicks on advertisements of advertiser 102, to generate keyword statistics 110. Keyword statistics 110 may then inform bidding behavior of advertiser 102.

### SUMMARY

In various embodiments, a computing device is configured to facilitate selection of keywords for bidding by an advertiser of a website. To facilitate selection, the computing device may process a click-through log to determine measures of competitiveness for a plurality of websites extracted from the click-through log. In some embodiments, the computing device may then, for one of the websites, determine a ranking of competing websites based at least in part on the measures of competitiveness. Also, in various embodiments, the computing device may, for a concept keyword of interest to an advertiser of one of the websites, determine a ranking of competing websites for that concept keyword based at least in part on the measures of competitiveness. Further, in some embodiments, the processing may further comprise determining one or more concept keywords for each of the plurality of websites, each concept keyword-website pair having an associated score, and calculating the measures of competitiveness based at least in part on the associated scores.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF DRAWINGS

Non-limiting and non-exhaustive examples are described with reference to the following Figures:

FIG. 1 illustrates a procedure used in traditional keyword tools;

FIG. 2 illustrates an overview of competitor analysis, in accordance with various embodiments;

FIG. 3 illustrates an exemplary operating environment including a computing device programmed with competitor analysis logic, in accordance with various embodiments;

FIGS. 4A-4C are flowchart views of exemplary operations of a competitor analysis, in accordance with various embodiments;

FIG. 5 illustrates an exemplary bipartite graph, in accordance with various embodiments;

FIG. 6 illustrates exemplary competitor analysis results, in accordance with various embodiments; and

FIG. 7 is a block diagram of an exemplary computing device.

### DETAILED DESCRIPTION

### Overview

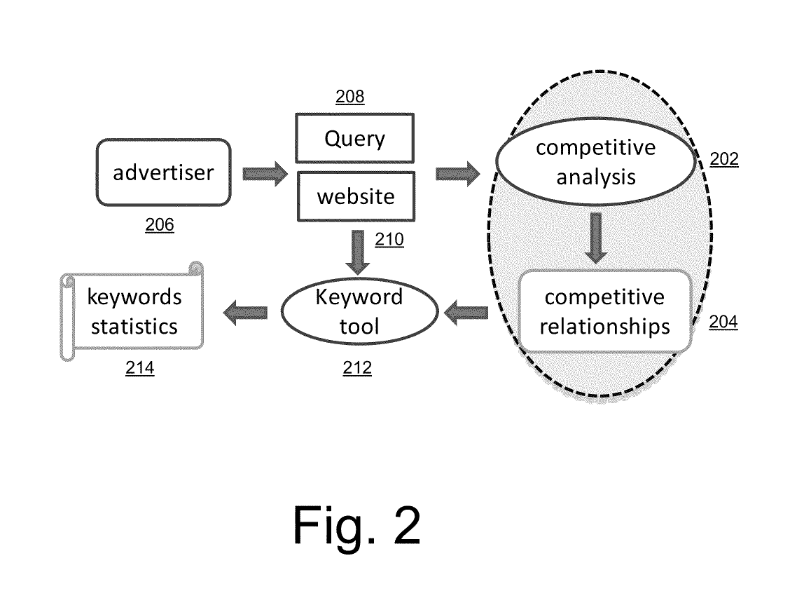

FIG. 2 illustrates an overview of competitor analysis, in accordance with various embodiments. As shown, a competitive analysis 202 may use the data resulting from user search behavior (queries 208 and click-throughs to websites 210 of advertisers 206 based on queries 208) to produce competitive relationships 204. The competitive relationships 204 may in turn facilitate selection of keywords for bidding. In some embodiments, as shown, a keyword tool 212 may utilize the competitive relationships 204 to produce further keyword statistics 214.

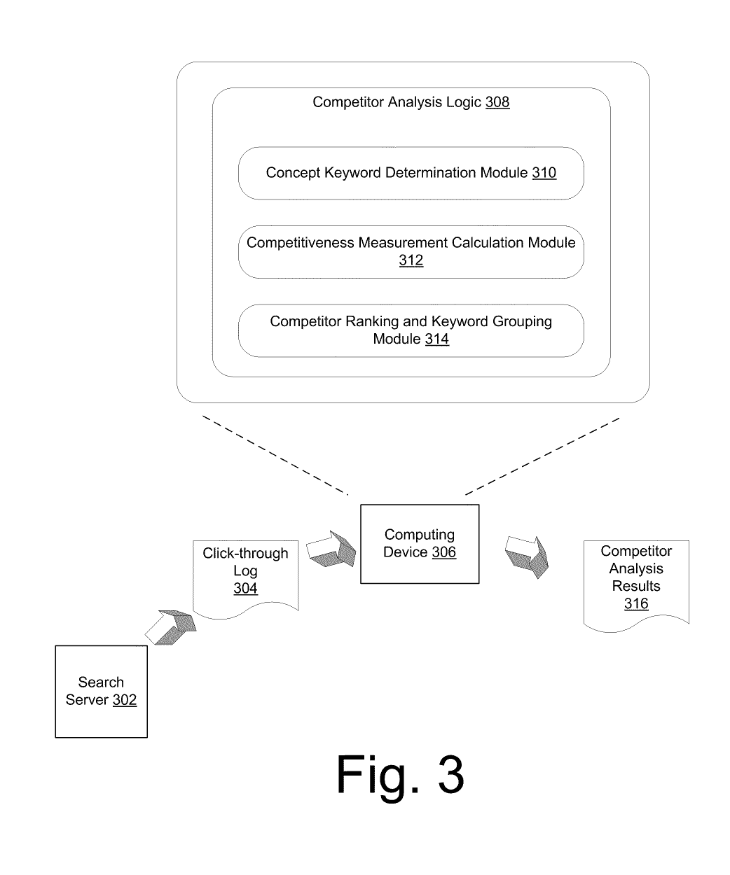

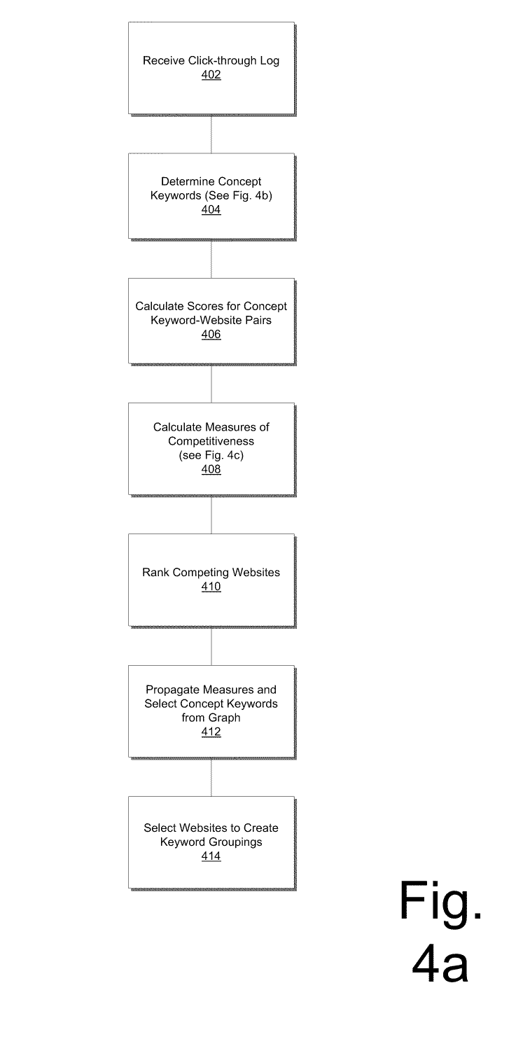

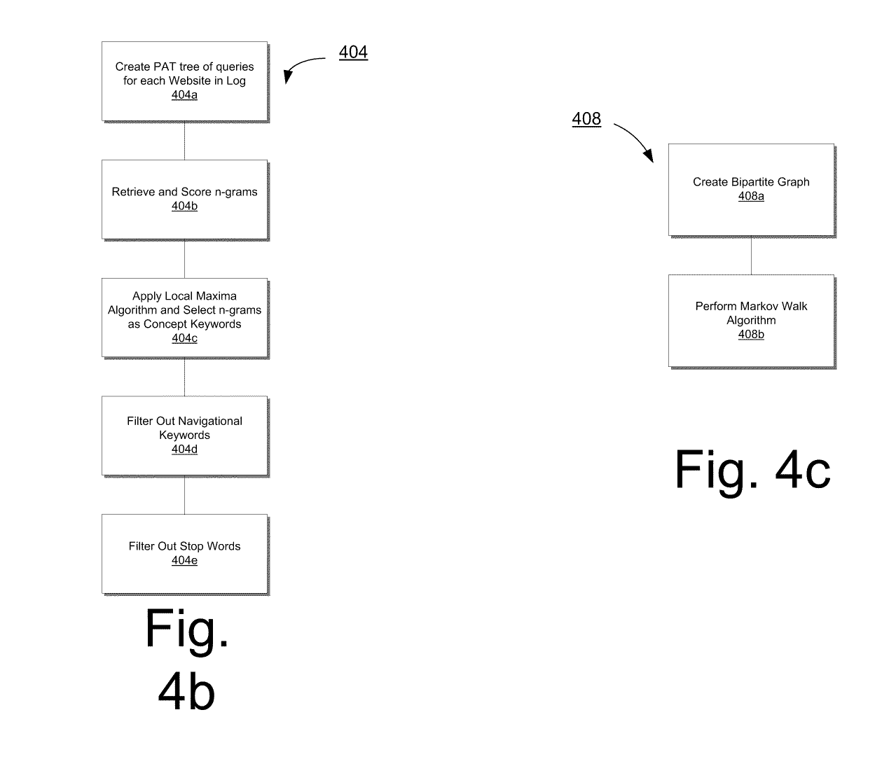

In various embodiments, the competitive analysis 202 may process a click-through log containing entries for queries 208 and websites 210 to determine measures of competitiveness for the websites 210. In some embodiments, this process may involve determining one or more concept keywords for each website 210, creating a bipartite graph of the concept keywords and websites 210, and performing a Markov walk algorithm on the graph to calculate the measures of competitiveness. These operations are described in greater detail below with reference to FIGS. 3 and 4. The competitive analysis 202 may further involve, for a given website of the websites 210, determining a ranking of competing websites based at least in part on the measures of competitiveness. Also, after calculating the measures of competitiveness, the competitive analysis 202 may determine a plurality of keyword groupings and assign competing websites to the groupings. In various embodiments, the ranking of competing websites and the keyword groupings may comprise at least a part of the competitive relationships 204.

### Exemplary Operating Environment

FIG. 3 is a block diagram illustrating an exemplary operating environment, in accordance with various embodiments. More specifically, FIG. 3 shows a computing device 306 that is programmed to perform a competitor analysis (also referred to herein as a “competitive analysis”, these terms being used interchangeably) based on data contained in a click-through log 304. In some embodiments, a search server 302 may provide the click-through log 304 to the computing device 306. As is further illustrated, the computing device 306 may be programmed with competitor analysis logic 308, the competitor analysis logic 308 being capable of producing a ranking of competing website for a given website as well as keyword groupings of competing websites, the ranking and groupings comprising the competitor analysis results 316. Further, competitor analysis logic 308 may include a plurality of modules, such as the concept keyword determination module 310, competitiveness measurement calculation module 312, and competitor ranking and keyword grouping module 314.

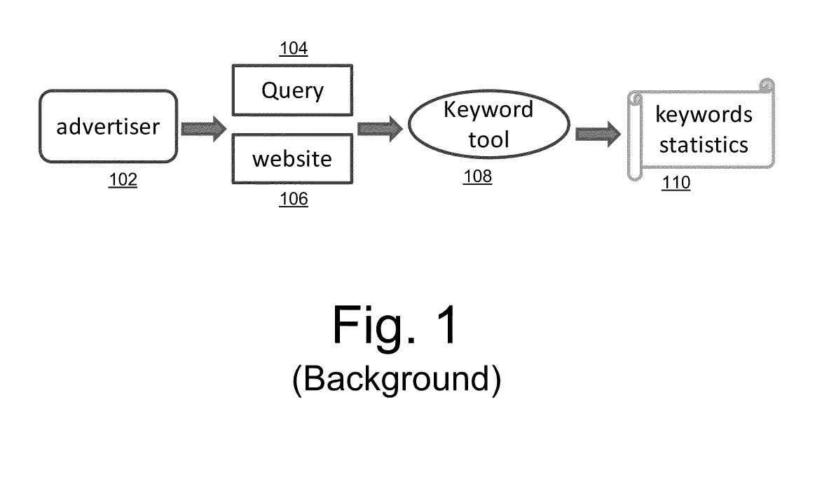

In various embodiments, the search server 302 may be any sort of computing device or devices known in the art, such as personal computers (PCs), laptops, servers, phones, personal digital assistants (PDAs), set-top boxes, and data centers. For example, search server 302 may be a server associated with Microsoft Windows Live Search or some other search application. Search server 302 may provide users with search capabilities, allowing users to enter search queries and receive, in response, a plurality of search results. In various embodiments, the search results may include the banner ads and sponsored links described above with regard to FIGS. 1 and 2. Search server 302 may then further monitor and record user clicks on sponsored links, banner ads, and/or search results. In some embodiments, the search server 302 may record these clicks and the queries that led to them in a click-through log 304. In other embodiments, rather than providing search facilities, search server 302 may simply be a storage server for storing click-though logs 304, the storage server receiving the click-through logs 304 from another server providing search services. In various embodiments, search server 302 may be configured to provide click-through logs 304 to other computing devices, such as computing device 306, in either a push or a pull manner.

In various embodiments, click-through log 304 can be a file of any format known in the art. For example, click-through log 304 may be a database file, a plain-text file, or an XML file. Further, click-through log 304 may comprise lists of queries and websites that a user clicked-through to in response to receiving the queries' search results. For example, click-through log 304 may comprise a table having queries in one column and websites in another column. A given query or website may repeat in a number of rows of the table, as one query might lead to click-throughs to several websites, and one website may be click-through to based on several queries. Table 1, below, illustrates an exemplary table of a click-through log 304. In some embodiments, in addition to queries and websites, the click-through log 304 may also store a frequency for each query website pair, the frequency being the number of times that the query resulted in a click-through to the website.

TABLE 1

| Query | Clicked Website |
|---|---|
| airline tickets | aa.com |
| airline tickets | expedia.com |
| travel hotel | expedia.com |
| travel hotel | hoteltravel.com |

As shown in FIG. 3, computing device 306 may be any sort of computing device or devices known in the art, such as personal computers (PCs), laptops, servers, phones, personal digital assistants (PDAs), set-top boxes, and data centers. In some embodiments, the computing device 306 may be a particular machine configured to perform some or all of the competitor analysis operations described above and below. As shown, computing device 306 may be programmed with competitor analysis logic 310 and may thus be capable of generating competitor analysis results 316 based on click-through logs 304. Computing device 306 may further be configured to receive or retrieve the click-through logs 304 from the search server 302, either as they are generated, at pre-determined times, or in response to a user command or request. In one embodiment, computing device 306 and search server 302 may be the same physical device, and click-through logs 304 may thus already be stored on computing device 306. In some embodiments, as illustrated in FIG. 2, the computing device 306 may provide the competitor analysis results 316 to a keyword tool 212 upon generating the results 316. FIG. 8 and its corresponding description below illustrate an exemplary computing device 306 in greater detail.

Also, in some embodiments, search server 302 and computing device 306 may be connected by at least one networking fabric (not shown). For example, the server 302 and device 306 may be connected by a local access network (LAN), a public or private wide area network (WAN), and/or by the Internet. In some embodiments, the server 302 and device 306 may implement between themselves a virtual private network (VPN) to secure the communications. Also, the server 302 and device 306 may utilize any communications protocol known in the art, such as the Transmission Control Protocol/Internet Protocol (TCP/IP) set of protocols. In other embodiments, rather than being coupled by a networking fabric, the server 302 and device 306 may be locally or physically coupled.

As is further illustrated in FIG. 3, computing device 306 may include and be programmed with competitor analysis logic 308 (hereinafter “logic 308”). Logic 308 may be any set of executable instructions capable of performing the operations described below with regard to modules 310-314. Logic 308 may reside completely on computing device 306, or may reside at least in part on one or more other computing devices and may be delivered to computing device 306 via the above-described networking fabric. While logic 308 is shown as comprising concept keyword determination module 310, competitiveness measurement calculation module 312, and competitor ranking and keyword grouping module 314, logic 308 may instead comprise more or fewer modules collectively capable of performing the operations described below with regard to modules 310-314. Thus, modules 310-314 are shown and described simply for the sake of illustration, and all operations performed by any of the modules 310-314 are ultimately operations of logic 308 that may be performed by any sort of module of logic 308.

In various embodiments, concept keyword determination module 310 (hereinafter “keyword module 310”) may determine one or more concept keywords for at least some of the websites appearing in the click-through log 304. A concept keyword may, for example, be a phrase that appears in several of the queries associated with a website and be an independent n-gram that has a semantic meaning. Further, the concept keyword may not be a navigational word or stop word. To determine the concept keywords for each website, keyword module 310 may first create a PAT tree for each website of the queries associated with that website. The keyword module 310 then calculates association scores for n-grams extracted from those queries and applies a local maxima algorithm to select the n-grams with the highest association scores as concept keywords. Next, the keyword module 310 filters out navigational words and stop words from the concept keywords, and calculates scores for each concept keyword based on its frequency of appearance among the queries for the website. Then, the keyword module 310 may select the top K concept keywords with the highest scores as the one or more concept keywords for the website. Keyword module 310 may then repeat these operations for some or all of the other websites listed in the click-through log 304.

As mentioned, keyword module 310 may first create a PAT tree (PAT tree is an abbreviation for “Patricia Tree”) for each website of the queries associated with that website. Keyword module 310 may organize the queries into a PAT tree, in some embodiments, to facilitate efficient retrieval of n-grams from the queries. PAT trees are well-known to those of ordinary skill in the art and accordingly will not be described further.

In various embodiments, keyword module 310 may then retrieve n-grams from the PAT tree. Each n-gram may be a sequence of one or more terms t₁, . . . , tₙ extracted from one or more queries of the query corpus organized by the PAT tree. Upon retrieving/extracting each n-gram, keyword module 310 may calculate a symmetric conditional probability (SCP) score for that n-gram. The keyword module 310 may use the SCP score to estimate the degree of association of the substrings comprising an n-gram. In some embodiments, the SCP score for an n-gram may be defined as:

$$S C P ( {t}_{1} , … , {t}_{n} ) = \frac{{p ( {t}_{1} , … , {t}_{n} )}^{2}}{\frac{1}{n - 1} {\sum }_{i = 1}^{n - 1} p ( {t}_{1} , … , {t}_{i} ) p ( {t}_{i + 1} , … , {t}_{n} )} \qquad Equation 1$$

where tⱼ is a term, t₁, . . . , tₙ is a sequence of terms comprising an n-gram, and p(t₁, . . . , tₙ) is a probability of the occurrence of the n-gram t₁, . . . , tₙ in the query corpus of the website. In some embodiments, if each substring of an n-gram has a similar occurrence to the n-gram, the SCP score for that n-gram will be high, indicating a strong degree of cohesion for that n-gram. For example, if the n-gram “airline tickets” appears 1000 times, and the substrings, “airline” and “tickets” each also appear 1000 times, that would indicate that the substrings only tend to appear together, as the n-gram. Such an n-gram will have a high SCP score, with what is considered “high” varying from embodiment to embodiment.

In some embodiments, after calculating the SCP score for each n-gram, the keyword module 310 may calculate the context dependency (CD) score for each n-gram. The CD score may help measure the lexical boundaries for each n-gram. In some embodiments, the CD score for an n-gram may be defined as:

$$CD ( {t}_{1} , … , {t}_{n} ) = \frac{LC ( {t}_{1} , … , {t}_{n} ) RC ( {t}_{1} , … , {t}_{n} )}{{freq ( {t}_{1} , … , {t}_{n} )}^{2}} \qquad Equation 2$$

where tⱼ is a term, t₁, . . . , tₙ is a sequence of terms comprising an n-gram, LC(t₁, . . . , tₙ) is the number of unique left adjacent words appearing in the query corpus of the website, and RC(t₁, . . . , tₙ) is the number of unique right adjacent words appearing in the query corpus of the website. LC( ) or RC( ) are equal to the frequency of the n-gram if there are no left adjacent or right adjacent words, respectively. The CD score can be used to determine if the n-gram is dependent on a certain string containing it. For example, if the n-gram only occurs when the string including it occurs, the score of the n-gram may be close to 0.

The keyword module 310 may then combine the SCP and CD scores by multiplying the SCP and CD scores together for each n-gram to arrive at an association/SCPCD score for each n-gram.

In various embodiments, after calculating the SCPCD scores for each n-gram, the keyword module 310 may apply a local maxima algorithm to the n-grams to select a number of algorithms having the highest SCPCD scores. Utilizing this algorithm, the keyword module 310 may compare the SCPCD score of an n-gram to its antecedent and successor n-grams. The antecedent n-gram may be a substring of the n-gram under consideration, having one less term than the n-gram under consideration. For example, if the n-gram is t₁, . . . , tₙ, its antecedent n-gram may be t₂, . . . , tₙ. The successor n-gram may be a string containing the n-gram under consideration, having one more term than the n-gram under consideration. For example, if the n-gram is t₁, . . . , tₙ, its successor n-gram may be t₁, . . . , tₙ₊₁. Keyword module 310 compares the score of the n-gram to its antecedent and successor n-grams, and if the score of the n-gram is the local maxima (i.e., is higher than that of the antecedent and successor), the n-gram is selected as a concept keyword. In some embodiments, the local maxima algorithm may be “relaxed” if the n-gram appears with a frequency exceeding some pre-determined threshold (i.e., even if the n-gram is not a local maxima, it may still be selected if it appears often enough).

In various embodiments, after selecting a number of n-grams as concept keywords, the keyword module 310 may filter out keywords having navigation roles. Keywords may have navigational roles if they contain terms similar to the URL of the website. To compute whether a term is navigational, the keyword module 310 may use the Levenshtein distance between the URL and the term. If the term is navigational, the keyword module 310 may filter the keyword associated with it out of the set of selected concept keywords. In some embodiments, however, before filtering out a keyword containing a navigational term, the keyword module 310 may check if the navigational term is present in a dictionary of terms determined to be “meaningful”, such as “games”, “weather”, or “shoes”, with what is “meaningful” varying from embodiment to embodiment. Also, in various embodiments, the keyword module 310 may filter out concept keywords that consist only of stop words.

In some embodiments, after filtering the selected concept keywords, the keyword module 310 may calculate scores for each of the concept keywords. The score may be unique to the pair of each concept keyword and a website (since the same concept keyword may be determined for multiple keywords, and have different scores for each). In various embodiments, keyword module 310 may calculate the score for each concept keyword based on the frequency of appearance of the concept keyword within the query corpus of the website for which the concept keyword was determined. In some embodiments, after calculating the scores, the keyword module 310 may select the top K scoring concept keywords as the one or more concept keywords determined for the website.

As further illustrated by FIG. 3, the competiveness measurement calculation module 312 (hereinafter “calculation module 312”) may utilize the websites, concept keywords, and scores for website-concept keyword pairs to generate a bipartite graph and perform a Markov walk algorithm. The result of the Markov walk algorithm may be a set of measures of competitiveness for the websites.

In various embodiments, calculation module 312 may first generate a bipartite graph of the concept keywords and websites. The bipartite graph may comprise two partitions: one for the concept keywords and another for the websites. Each concept keyword and website may be represented by a node. The concept keyword nodes may each be connected to one or more websites by an edge, and the websites may be connected by those same edges to one or more concept keywords. Also, each edge may be associated with a score of the concept keyword-website pair that it represents, those scores described in greater detail above.

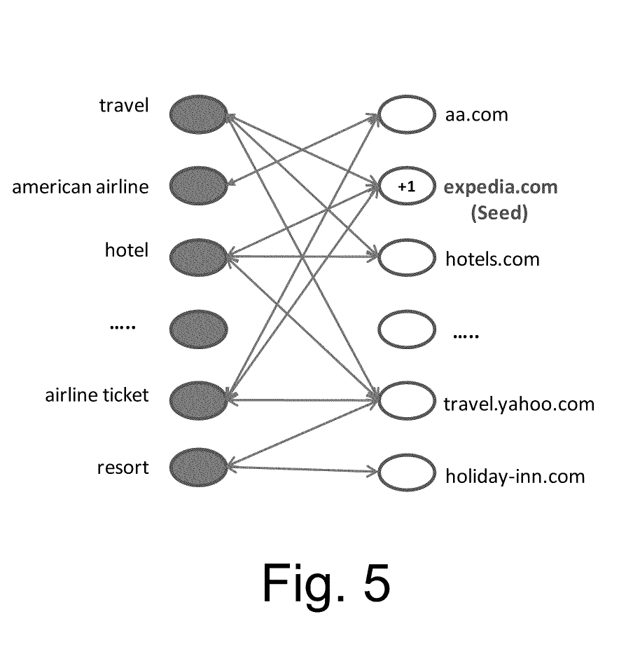

An exemplary bipartite graph is illustrated by FIG. 5. As shown, the left “side”/partition includes a number of concept keywords, including “travel”, “airline ticket”, and “hotel”. The right “side”/partition includes a number of websites, including “aa.com”, “expedia.com”, and “hotels.com.” As illustrated, expedia.com is connected to travel, hotel, and airline ticket. Those concept keywords may correspond to the concept keywords determined for expedia.com by the keyword module 310.

In various embodiments, after creating the bipartite graph, calculation module 312 may perform a Markov walk algorithm on the graph. As a preliminary to performing the algorithm, however, the calculation module 312 may first calculate transition probability matrices based on the scores associated with each edge. For a graph with n concept keywords and m websites, there is an m×n symmetric matrix of scores. The matrix would be symmetric because the score for entry m₁n₁ would be the same as the score for n₁m₁. Once the score matrix is defined, the calculation module 312 may use it to define two transition probability matrices. The first transition probability matrix includes transition probabilities from a website wⱼ at a time t to a concept keyword cₖ at time t+1 (with j ranging from 1 to m and k ranging from 1 to n). The probabilities of the first matrix may be defined to normalize out wⱼ, such that:

$${P}_{t + 1 \vert t} ( {c}_{k} \vert {w}_{j} ) = \frac{{s}_{jk}}{{\sum }_{i} {s}_{ji}} \qquad Equation 3$$

where sⱼₖ is the score entry in the m×n matrix at wᵢcₖ, P_{t+1|t} (cₖ|wⱼ) denotes the transition probability from wⱼ at a time t to cₖ at time t+1, and wherein i ranges over all concept keywords connected to wⱼ. Based on the defined probabilities, the first matrix P_{wc} may be defined as [P_{t+1|t} (cₖ|wⱼ)]ⱼₖ. The size of the matrix P_{wc} would also be m×n and would be row stochastic (i.e., the entries for a given row would sum to 1).

The second transition probability matrix includes transition probabilities from a concept keyword cₖ at a time t to a website wⱼ at time t+1. The probabilities of the second matrix may be defined to normalize out cₖ, such that:

$${P}_{0} ( {w}_{j} \vert {s}_{i} ) = \frac{{f}_{jz}}{{\sum }_{j} {f}_{zj}} , j = 1 , … , m \qquad Equation 4$$

where sⱼₖ is the score entry in the m×n matrix at wⱼcₖ, P_{t+1|t} (wⱼ|cₖ) denotes the transition probability from cₖ at a time t to wⱼ at time t+1, and wherein i ranges over all websites connected to cₖ. Based on the defined probabilities, the second matrix P_{cw} may be defined as [P_{t+1|t} (wⱼ|cₖ)]ₖⱼ. The size of the matrix P_{wc} would be n×m and would also be row stochastic (i.e., the entries for a given row would sum to 1).

After defining the two probability matrices, the calculation module 312 may then define an initial vector v⁰ by assigning an initial value to each website. In calculating the vector v⁰, the calculation module 312 may select one of the websites as a “seed node”. In some embodiments, calculation module 312 may select the website for which competitors are to be determined as the “seed node”. The seed node is assigned a value of 1, and all other nodes in the vector (i.e., all other websites in the graph) are assigned values of 0.

With the vector v⁰ and probability matrices P_{wc} and P_{cw} as inputs, calculation module 312 may perform a Markov walk algorithm. The Markov walk may initialize a variable v to v⁰ and then repeat, until a convergence point is reached, the following operations:

compute u=P_{wc}^{T}v;

compute v=α P_{cw}^{T}u+(1−α) v⁰, where α ∈ [0,1)

For example, referring again to FIG. 5, the Markov walk may start with a value of 1 assigned to expedia.com and 0 assigned to each other website. The calculation module 312 may then propagate the value assigned to expedia.com to the concept keywords connected to expedia.com based on the transition probabilities from expedia.com at time t to the concept keywords at time t+1. Mathematically, this is shown above in the computation u=P_{wc}^{T}v. Each of the concept keywords connected to expedia.com may receive a fractional weight, the fractional weights adding to 1. The calculation module 312 may then propagate the fractional weights of each of these concept in turn to the websites to which each is connected, and may divide each weight between the websites based on the transition probabilities from those concept keywords at time t to the websites at time t+1. Mathematically, this is shown above in the computation v=a P_{cw}^{T}u+(1−a)v⁰, where a is between 0 and 1.

In various embodiments, the Markov walk may be considered complete when v asymptotically converges to a result vector v*. The result vector v* may also be a one-dimensional vector with most or all of the websites having a score/weight between 0 and 1, and the sum of all weights/scores equaling 1. These scores may represent the posterior probabilities that a website wⱼ is associated with the seed node (the website initially assigned a value of 1). Since these posterior probabilities may reflect a degree of competition with the seed node, they may serve as measures of competitiveness/competition scores for each website.

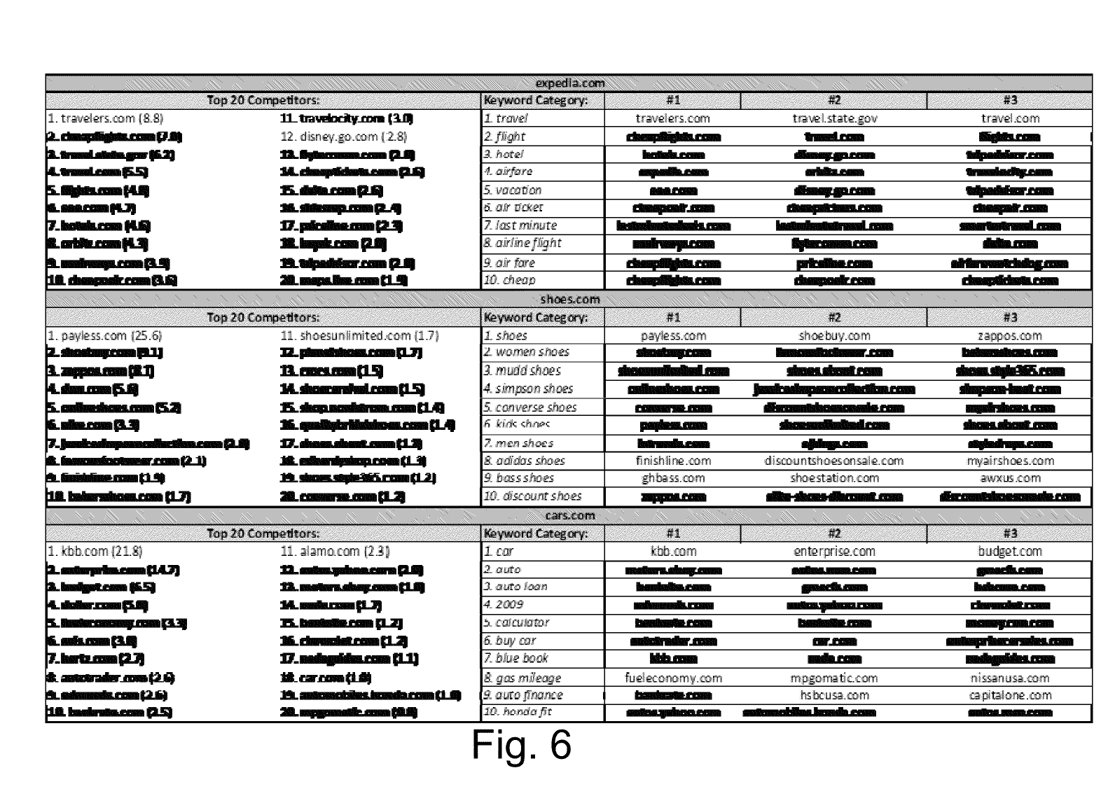

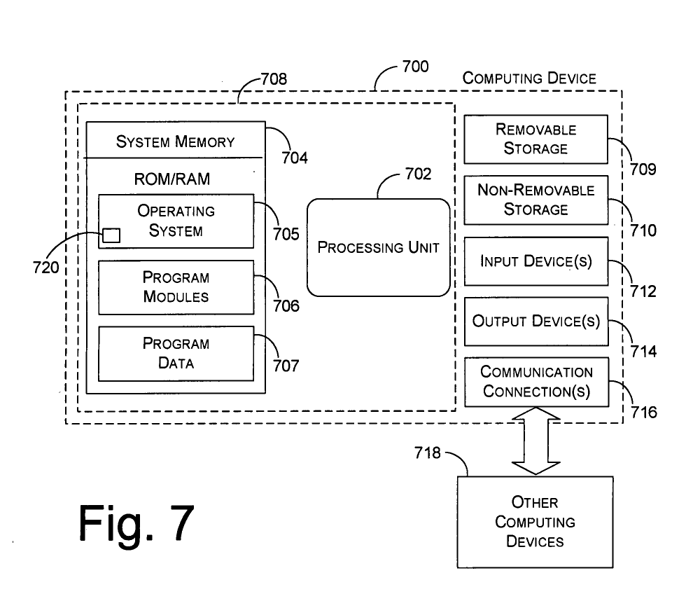

As is further illustrated by FIG. 3, the competitor ranking and keyword grouping module 314 (hereinafter “ranking module 314”) may determine a ranking of competitors based on the measures of competitiveness and keyword groupings of competitors based on the bipartite graph and measures of competitiveness. To determine the ranking of competing websites, ranking module 314 may simply select the top N websites (excluding the seed node/website) based on the measures of competitiveness, and order the competing websites in descending order based on the measures of competiveness. For example, FIG. 6, on the left hand side, illustrates rankings for 3 different seed nodes/websites. For each of these websites, the top 20 competing websites (and their measures of competitiveness) are shown. Thus, for the website expedia.com, the top competing website is travelers.com and the measure of competitiveness of travelers.com is 8.8. 8.8 represents a percentage which, when added to other percentages/measures of competitiveness, adds to 100%—or 1—the value initially assigned to the seed node/website.

In various embodiments, after determining the ranking, ranking module 314 may also determine keyword groupings of competing websites. To determine concept keywords to select for groupings, the ranking module 314 may propagate the measures of competitiveness from the nodes of the bipartite graphs associated with the competing websites to the concept keywords associated with those websites. As with the Markov walk algorithm above, the propagation may be based on the transition probabilities from the websites at time t to the concept keywords at time t+1. After propagating the measures of competitiveness to the concept keywords, the ranking module 314 may select the top N concept keywords—based on the propagated scores—as keywords around which to build keyword groupings. Each keyword grouping may comprise such a selected concept keyword and the top competing websites for that concept keyword. After selecting the concept keywords, the ranking module 314 may determine the top competing websites for each concept keyword. In various embodiments, the ranking module 314 may determine the top competing websites for a concept keyword based on the scores associated with each concept keyword-website pair or based on transition probabilities. The websites with the highest scores/transition probabilities for a concept keyword may be selected as the website comprising the keyword grouping.

For example, FIG. 6 illustrates, on the right hand side, keyword groupings labeled “travel”, “hotel”, and “airfare.” Next to each of those concept keywords is shown the top three competing websites for that keyword. Thus, the websites travelers.com, travel.state.gov, and travel.com are shown in descending order next to the concept keyword “travel.”

As is further shown in FIG. 3, the competitor analysis logic 308 may produce competitor analysis results 316. As mentioned above, these results 316 may include the rankings of competing websites and the keyword groupings of competing websites. Exemplary competitor analysis results 316 are illustrated by FIG. 6 and described above in greater detail. Competitor analysis results 316 may be produced in any file format known in the art, such as a text file, an XML file, or a web page. Once produced, competitor analysis results 316 may be provided to a keyword tool 212 or the like to facilitate selection of keywords for bidding. For example, if expedia.com learns that its top competing website is travelers.com, expedia.com can concentrate its bidding on keywords associated with queries that had the highest click-through to travelers.com.

### Exemplary Operations

FIGS. 4A-4C are flowchart views of exemplary operations of a competitor analysis, in accordance with various embodiments. As illustrated in FIG. 4A, one or more computing devices (such as the computing devices described above with reference to FIG. 3) may first receive or retrieve a click-through log, block 402. In various embodiments, the click-through log may include triplets of a query, a website, and a frequency that the query resulted in a click-through to the website.

The computing devices may then determine one or more concept keywords for each of a plurality of websites extracted from the click-through log, block 404. The determining of the one or more concept keywords, block 404, is further illustrated by FIG. 4B and described in greater detail below.

In some embodiments, the computing devices may then calculate associated scores for each concept keyword-website pair based on frequencies that queries extracted from the click-through log resulted in click-throughs to websites, block 406.

In various embodiments, the computing device may then calculate measures of competitiveness for the plurality of websites based at least in part on the associated scores, block 408. The calculating, block 408, is further illustrated by FIG. 4C and described in greater detail below.

As shown in FIG. 4A, the computing device may then determine a ranking of competing websites based at least in part on the measures of competitiveness, block 410, to facilitate selection of keywords for bidding by an advertiser of the one of the plurality of websites.

In various embodiments, the computing device may then propagate measures of competitiveness to nodes of the concept keywords in a bipartite graph (described in FIG. 4C) and select a number of concept keywords based on the measures of competitiveness, block 412.

After selecting the concept keywords, the computing device may then select a number of websites associated with the selected number of concept keywords to create keyword groupings of competing websites, block 414.

FIG. 4B illustrates the determining of concept keywords, block 404, in accordance with some embodiments. As shown, the determining may first include, for each website, creating a PAT tree of queries associated with that website, block 404a.

Next, the determining may include retrieving n-grams from the queries and calculating scores for the n-grams, block 404b. In some embodiments, the n-gram scores may include one or both of symmetrical conditional probabilities and/or context dependencies.

In various embodiments, the computing device may then apply a local maxima algorithm to the n-grams and, based on results of the algorithm, selecting one or more of the n-grams as the one or more concept keywords, block 404c

The computing device may then filter out navigational keywords from the concept keywords based on comparisons of the concept keywords to website identifiers, block 404d, and/or filter out stop words from the concept keywords, block 404e.

FIG. 4C illustrates the calculating of measures of competitiveness, block 408, in accordance with various embodiments. As shown, the calculating may further include creating bipartite graph, block 408a, each edge of graph being associated with a concept keyword-website pair score.

The calculating may further include performing a Markov walk algorithm on the bipartite graph, block 408b . In some embodiments, performing the Markov walk algorithm may further include propagating a weight assigned to a seed node of the bipartite graph between partitions of the bipartite graph based on the concept keyword-website pair scores until a convergence point is reached.

### Exemplary Computing Device

FIG. 7 illustrates an exemplary computing device 700 that may be configured to facilitate selection of keywords by performing a competitor analysis.

In a very basic configuration, computing device 700 may include at least one processing unit 702 and system memory 704. Depending on the exact configuration and type of computing device, system memory 704 may be volatile (such as RAM), non-volatile (such as ROM, flash memory, etc.) or some combination of the two. System memory 704 may include an operating system 705, one or more program modules 706, and may include program data 707. The operating system 705 may include a component-based framework 720 that supports components (including properties and events), objects, inheritance, polymorphism, reflection, and provides an object-oriented component-based application programming interface (API), such as that of the .NET™ Framework manufactured by Microsoft Corporation, Redmond, Wash. The device 700 may be of a configuration demarcated by a dashed line 708.

Computing device 700 may also have additional features or functionality. For example, computing device 700 may also include additional data storage devices (removable and/or non-removable) such as, for example, magnetic disks, optical disks, or tape. Such additional storage is illustrated in FIG. 7 by removable storage 709 and non-removable storage 710. Computer storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of device 700. Computing device 700 may also have input device(s) 712 such as keyboard, mouse, pen, voice input device, touch input device, etc. Output device(s) 714 such as a display, speakers, printer, etc. may also be included. These devices are well know in the art and need not be discussed at length here.

Computing device 700 may also contain communication connections 716 that allow the device to communicate with other computing devices 718, such as over a network. Communication connections 716 are one example of communication media. Communication media may typically be embodied by computer readable instructions, data structures, program modules, etc.

### Closing Notes

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

References are made in the detailed description to the accompanying drawings that are part of the disclosure and which illustrate embodiments. Other embodiments may be utilized and structural or logical changes may be made without departing from the scope of the disclosure. Therefore, the detailed description and accompanying drawings are not to be taken in a limiting sense, and the scope of embodiments is defined by the appended claims and equivalents.

Various operations may be described, herein, as multiple discrete operations in turn, in a manner that may be helpful in understanding embodiments; however, the order of description should not be construed to imply that these operations are order-dependent. Also, embodiments may have fewer operations than described. A description of multiple discrete operations should not be construed to imply that all operations are necessary.

The description may use perspective-based descriptions such as up/down, back/front, and top/bottom. Such descriptions are merely used to facilitate the discussion and are not intended to restrict the scope of embodiments.

The terms “coupled” and “connected,” along with their derivatives, may be used herein. These terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in embodiments,” which may each refer to one or more of the same or different embodiments. Furthermore, the terms “comprising,” “including,” “having,” and the like, as used with respect to embodiments, are synonymous.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

1. A system comprising:
a processor; and
logic configured to be executed by the processor to:
receive a click-through log which includes triplets of a query, a website address of a website, and a frequency that the query resulted in a click-through to the website;
determine one or more concept keywords for each of a plurality of websites extracted from a click-through log, each concept keyword-website pair having an associated score, the determining including:
for each website, creating a PAT tree of queries associated with that website,
retrieving n-grams from the queries and calculating scores for the n-grams, and
applying a local maxima algorithm to the n-grams and, based on results of the algorithm, selecting one or more of the n-grams as the one or more concept keywords;
calculate measures of competitiveness of at least some of the websites based at least in part on the associated scores, the calculating including:
creating bipartite graph, each edge of graph being associated with a concept keyword-website pair score, and
performing a Markov walk algorithm on the bipartite graph, the Markov walk algorithm including propagating a weight assigned to a seed node of the bipartite graph between partitions of the bipartite graph based on the concept keyword-website pair scores until a convergence point is reached; and
for one of the websites, determine a ranking of competing websites based at least in part on the measures of competitiveness to facilitate selection of keywords for bidding by an advertiser of the one of the plurality of websites.

2. The system of claim 1, wherein the logic is further configured to be executed to:
propagate measures of competitiveness to nodes of the concept keywords in the bipartite graph and selecting a number of concept keywords based on the measures of competitiveness; and
select a number of websites associated with the selected number of concept keywords to create keyword groupings of competing websites.

3. A method comprising:
processing, by a computing device, a click-through log to determine measures of competitiveness for a plurality of websites extracted from the click-through log; and
for one of the websites, determining, by the computing device, a ranking of competing websites based at least in part on the measures of competitiveness to facilitate selection of keywords for bidding by an advertiser of the one of the plurality of websites.

4. The method of claim 3 further comprising receiving the click-through log which includes triplets of a query, a website address of a website, and a frequency that the query resulted in a click-through to the website.

5. The method of claim 3, wherein the processing further comprises:
determining one or more concept keywords for each of the plurality of websites, each concept keyword-website pair having an associated score; and
calculating the measures of competitiveness based at least in part on the associated scores.

6. The method of claim 5 further comprising calculating the associated scores based on frequencies that queries extracted from the click-through log resulted in click-throughs to websites.

7. The method of claim 5, wherein determining the concept keywords further includes, for each website, creating a PAT tree of queries associated with that website.

8. The method of claim 5, wherein determining the concept keywords further includes retrieving n-grams from the queries and calculating scores for the n-grams.

9. The method of claim 8, wherein the n-gram scores include one or both of symmetrical conditional probabilities and/or context dependencies.

10. The method of claim 8, wherein determining the concept keywords further includes applying a local maxima algorithm to the n-grams and, based on results of the algorithm, selecting one or more of the n-grams as the one or more concept keywords.

11. The method of claim 5, wherein determining the concept keywords further includes filtering out navigational keywords from the concept keywords based on comparisons of the concept keywords to website identifiers and/or filtering out stop words from the concept keywords.

12. The method of claim 5, wherein the calculating further includes creating bipartite graph, each edge of graph being associated with a concept keyword-website pair score.

13. The method of claim 12, wherein the calculating further includes performing a Markov walk algorithm on the bipartite graph.

14. The method of claim 13, wherein performing the Markov walk algorithm further includes propagating a weight assigned to a seed node of the bipartite graph between partitions of the bipartite graph based on the concept keyword-website pair scores until a convergence point is reached.

15. The method of claim 12 further comprising propagating measures of competitiveness to nodes of the concept keywords in the bipartite graph and selecting a number of concept keywords based on the measures of competitiveness.

16. The method of claim 15 further comprising selecting a number of websites associated with the selected number of concept keywords to create keyword groupings of competing websites.

17. An article of manufacture comprising:
a storage medium; and
a plurality of executable instructions stored on the storage medium which, when executed, program a computing device to perform operations including:
determining one or more concept keywords for each of a plurality of websites extracted from a click-through log, each concept keyword-website pair having an associated score;
calculating measures of competitiveness of at least some of the websites based at least in part on the associated scores; and
for a concept keyword of interest to an advertiser of one of the websites, determining a ranking of competing websites for that concept keyword based at least in part on the measures of competitiveness to facilitate bidding by the advertiser.

18. The article of claim 17, wherein the executable instructions, when executed, further program the computing device to perform operations including:
creating bipartite graph, each edge of graph being associated with a concept keyword-website pair score; and
performing a Markov walk algorithm on the bipartite graph, the Markov walk algorithm including propagating a weight assigned to a seed node of the bipartite graph between partitions of the bipartite graph based on the concept keyword-website pair scores until a convergence point is reached.

19. The article of claim 18, wherein determining the ranking further includes propagating measures of competitiveness to nodes of the concept keywords in the bipartite graph and selecting a number of concept keywords based on the measures of competitiveness.

20. The article of claim 19, wherein determining the ranking further includes selecting a number of websites associated with the selected number of concept keywords to create keyword groupings of competing websites.
